(19) United States
(12) Patent Application Publication
(10) Pub. No.: US 2026/0006408 A1
(43) Pub. Date: Jan. 1, 2026

(54) AUTOMATED NODE IDENTIFIER ASSIGNMENT FOR SHARED COMMUNICATION MEDIUMS

(71) Applicant: TOSHIBA GLOBAL COMMERCE SOLUTIONS, INC., Durham, NC (US)

(72) Inventors: Charles Ray KIRK, Raleigh, NC (US); Philip S. BROWN, Cary, NC (US); Viktor DANYLCHENKO, Kharkiv (UA); Vitaliy BOKOV, Wroclaw (PL)

(21) Appl. No.: 18/754,655

(22) Filed: Jun. 26, 2024

(51) Int. Cl. H04W 4/06; H04W 76/11

(52) U.S. Cl. CPC H04W 4/06; H04W 76/11

(57) ABSTRACT

Method and apparatus for node identifier assignment for shared communication mediums are provided. A node identifier (ID) is selected for communication via a network. A broadcast delay is determined, and a set of received messages received prior to expiration of the broadcast delay is evaluated to determine that none of the set of received messages comprise the node ID. In response to determining that none of the set of received messages comprises the node ID, a set of broadcast messages comprising the node ID is broadcasted. In response to determining, based on the set of broadcast messages, that the node ID is nonconflicting in the network, the node ID is used for one or more subsequent communications.

### BACKGROUND

A variety of communication network architectures rely on a shared medium that is accessed and used by multiple network devices that use the network for communication. For example, wireless networks using radio frequency (RF) transmissions share the RF medium, such that simultaneous transmissions may cause interference. Similarly, some wired networks (such as 10Base-T1S networks) use a shared medium (e.g., a single line or bus, such as a single unshielded twisted pair bus line). To enable effective communication using such networks, provisions to prevent (or deal with) collisions are used (e.g., to prevent multiple devices from using the shared bus line at the same time).

### BRIEF DESCRIPTION OF THE DRAWINGS

FIG. 1 depicts an example environment for enabling efficient use of a shared communication medium, according to some embodiments of the present disclosure.

FIGS. 2A and 2B depict an example workflow for efficient identifier assignment for shared medium communication, according to some embodiments of the present disclosure.

FIG. 3 is a flow diagram depicting an example method for efficient use of a shared communication medium, according to some embodiments of the present disclosure.

FIG. 4 is a flow diagram depicting an example method for automated identifier assignment for communication using a shared medium, according to some embodiments of the present disclosure.

FIG. 5 is a flow diagram depicting an example method for selecting node identifiers for communication, according to some embodiments of the present disclosure.

FIG. 6 depicts an example computing device for selecting identifiers for communication, according to some embodiments of the present disclosure.

### DETAILED DESCRIPTION

Embodiments of the present disclosure provide techniques and systems for efficient and automated identifier assignment to enable effective use of a shared communication mediums among devices.

Some conventional mechanisms to manage access to the shared medium include a time slot reservation system, where each device uses a unique identifier, and time slots are assigned to each identifier. Each node may then communicate using the shared medium when the corresponding time slot arrives. However, in conventional systems, there is no efficient approach to assign such identifiers. For example, many architectures use a static identifier assignment (e.g., manually configured when a device is added to the network). This relies on substantial pre-configuration of each device, which can be time consuming and error prone (especially for larger networks with multiple similar or equivalent devices).

In some embodiments, network devices (also referred to as nodes in some embodiments) use a shared communication medium (e.g., a wireless medium, or one or more wires, such as a twisted pair) to communicate with each other and/or other systems using a time slot-based assignment, where each node is entitled to conflict-free access to the medium during a corresponding assigned time slot. For example, the nodes may operate in a round-robin fashion, where a first node uses the medium to send and/or receive data for one period of time, followed by a second node, a third node, and so on until each node has had the opportunity to use the medium. The process may then repeat at the first node.

In some embodiments, the network may be 10Base-T1S or similar. Such network architectures may have benefits such as easy reconfiguration of the network. For example, a single shared bus may be arranged in physical space (e.g., a twisted pair running around a store, up an elevator shaft, and the like) and nodes may be added or removed from the shared bus easily without requiring new communication lines to be run to each new node (or removed for each removed node).

In some embodiments, the system uses unique identifiers (IDs) for each device in order to manage the time slot assignment. However, as discussed above, there is no conventional approach to handle the ID assignment (other than manually assigning identifiers as devices are added to the network). This can cause collisions (e.g., if an identifier is mistakenly re-used) and substantially complicates reconfiguration of the network (e.g., to add or remove nodes), as the identifier assignments are often separately tracked and manually maintained by network administrators.

Embodiments of the present disclosure provide techniques to allow network devices to automatically select unique identifiers for communication, enabling rapid and efficient onboarding of new devices to the network while preventing communication collisions. In some embodiments, at power up (or upon being added to the network, such as when the shared bus is connected to the new device), the device selects a node ID (e.g., randomly or based on prior configuration, as discussed in more detail below). The new device may then evaluate whether the selected ID is already in-use in the network, such as by listening to transmitted messages, attempting communication and monitoring for collision, and the like. If the selected ID is already in use, the device can rapidly select a new ID until an unused alternative is found. In this way, new devices can automatically select an ID and bring themselves online without relying on manual intervention or configuration.

### Example Environment for Enabling Efficient Use of a Shared Communication Medium

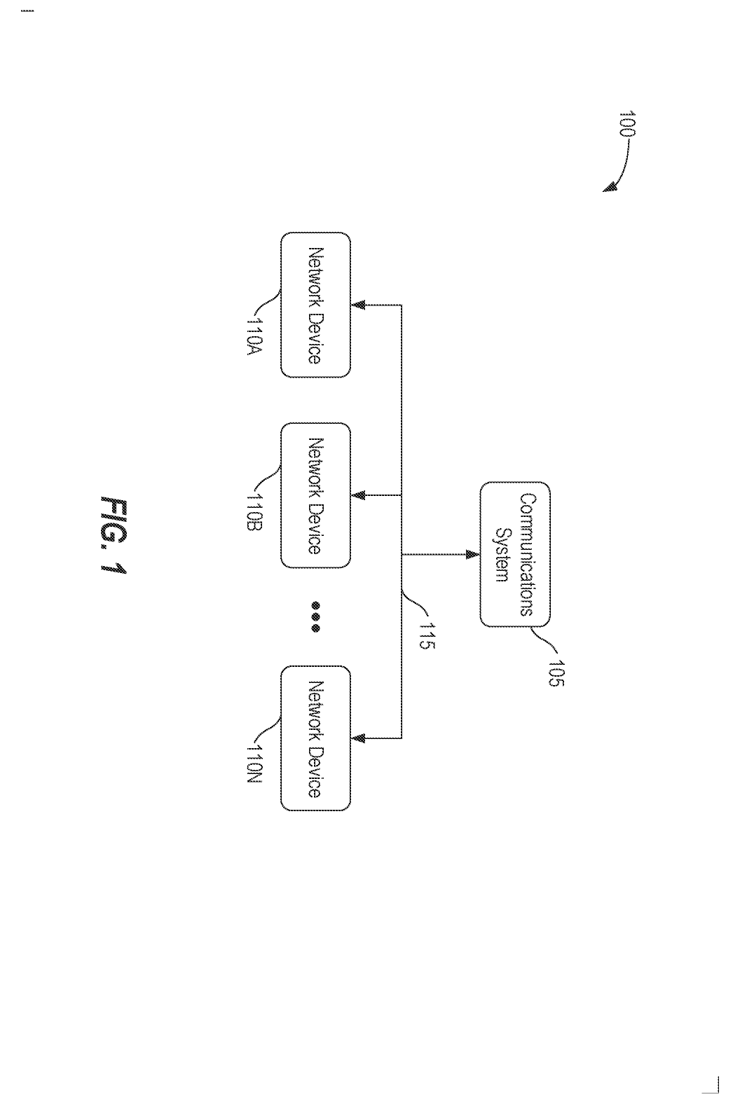

FIG. 1 depicts an example environment 100 for enabling efficient use of a shared communication medium, according to some embodiments of the present disclosure.

In the illustrated environment 100, a set of network devices 110A-N (collectively, network devices 110) communicate using a shared medium 115 (e.g., a bus, such as a single twisted pair connecting the network devices 110). In the illustrated example, the network devices 110 use the network (e.g., the medium 115) to communicate with each other and/or with a communications system 105. For example, the communications system 105 may correspond to a central controller or component that uses the network devices 110 to perform tasks. As one non-limiting example, the network devices 110 may correspond to components of a vehicle (e.g., radar sensors, ultrasonic sensors, and the like) and the communications system 105 may correspond to a controller that uses the sensor data to provide driving assistance actions (e.g., object detection and collision avoidance). As another example, the network devices 110 may be sensors (e.g., pressure pads) in a retail space (e.g., on shelves in a commercial store), and the communications system 105 may correspond to a controller that uses the sensor data to track objects in the physical space (e.g., as they are removed or moved from the shelves).

Although the illustrated example depicts three network devices 110, there may be any number of network devices in the network. Further, although the illustrated example depicts a discrete communications system 105, there may any number of such systems (including zero) in the network. That is, the network may include network devices 110 that communicate with each other using the medium 115, without any centralized control or system. Stated differently, in some aspects, the communications system 105 may be absent, or may be implemented as a network device 110.

In the illustrated example, each network device 110 and the communications system 105 is generally representative of any computing device capable of transmitting and/or receiving data using the medium 115. The medium 115 is generally representative of any communication medium that can be used to communicate data, including wireless medium(s), wired mediums, and the like. As illustrated, the medium 115 may be referred to as “shared” to indicate that the network devices 110 and communications system 105 all have access to the same medium 115, and may all use the same medium 115 to communicate. As discussed above, this may result in collisions or interference between messages if not controlled.

In some embodiments, as discussed above, the participating network nodes (e.g., the network devices 110 and communications system 105) that use the medium 115 may each use a unique ID (referred to in some embodiments as a node ID) to enable conflict-free communication. For example, each identifier may be assigned a corresponding time slot (e.g., a period of time), and the nodes may determine when their turn to use the medium arrives based on their respective identifiers.

In some embodiments, one of the nodes (e.g., the node using node ID 0) may act to control the time slot system, such as by sending out beacons indicating the start of the time slot rotation. For example, the node may broadcast a beacon using the medium 115 indicating the beginning of the rotation. The first defined time period may then be used by the first node (e.g., the node using identifier 0), followed by the node using ID 1, and so on. When the final time period in the rotation is complete, the first node may send a new beacon indicating the beginning of a new rotation.

In some embodiments, at the beginning of each time slice, a relatively brief period is provided to allow the corresponding node to begin communication. If the node begins transmitting during this window, the other nodes may refrain from transmitting, allowing the node to have conflict-free access to the medium 115 to complete their transmission (or until the time slice elapses). In some embodiments, if the node does not begin transmitting during this brief initial window, the remaining nodes may infer that the node does not have any data for transmission, and the time slice may be truncated (e.g., ending the current period and passing control of the medium 115 immediately to the next node in the rotation to avoid delay).

As discussed above, in embodiments of the present disclosure, each node may automatically select a unique node ID to enable collision-free communication using the shared medium 115.

For example, in some embodiments, upon powering up or otherwise initiating connection via the medium 115, each node may select a node ID between one and a maximum node ID (e.g., based on the maximum number of devices that can use the medium 115). For example, the node may select this initial ID randomly, or based on prior configuration (e.g., selecting the ID that the node used previously, such as before a system restart).

In some embodiments, each node may similarly select or determine a broadcast delay between zero and a defined maximum broadcast delay. In some embodiments, each node may similarly select the broadcast delay randomly, as discussed in more detail below.

In some embodiments, after this initialization, the node may monitor or evaluate messages received via the medium 115 to eliminate conflicts before proceeding. For example, in some embodiments, the node begins listening to broadcast messages (via the medium 115) from other nodes while waiting until the determined broadcast delay elapses. During this time, if a message is received that uses the ID selected by the node, the process would restart (e.g., the node would select a different node ID, such as randomly).

In some embodiments, after the broadcast delay elapses, the node may begin to broadcast an ID selection message via the medium 115 (e.g., sending one or more messages during the corresponding time slot to indicate that the node will begin using the selected ID for communication). In some embodiments, the node may continue to listen to incoming messages for conflicts, and/or may check status registers or other mechanisms that indicate whether another node transmitted in the selected time slot.

In some embodiments, the node can repeat this broadcasting process until either a conflict is detected (e.g., another node transmits a message using the selected identifier and/or another node attempts to use the communication medium 115 at the same time), in which case the process may be restarted (e.g., to select a new ID). In some embodiments, if the broadcasting is performed without detecting conflict until the allocation process has completed (e.g., based on determining that a defined period of time has elapsed without detecting a conflict), the node finalizes its ID selection and may begin using the selected ID for communication using the medium 115. For example, the node may begin transmitting data during the corresponding time slot based on the selected ID, and may include the ID in its transmitted messages.

In some embodiments, once the allocation is finalized, the node may save or record the selected ID in non-volatile memory or storage. If a re-allocation process is used (e.g., if the node is power cycled or otherwise re-enrolls in the network), the node may use this saved ID as the initial selected ID for next cycle. For example, if one or more nodes are restarted (e.g., due to power loss or system reboot), they may each begin using the ID they previously determined was conflict-free, enabling rapid return to normal functionality of the network. In this way, the nodes may renegotiate their node IDs if there is a change in the physical configuration of the network, such as when a new device is added to the medium 115, but may not renegotiate in other cases.

### Example Workflow for Efficient Identifier Assignment for Shared Medium Communication

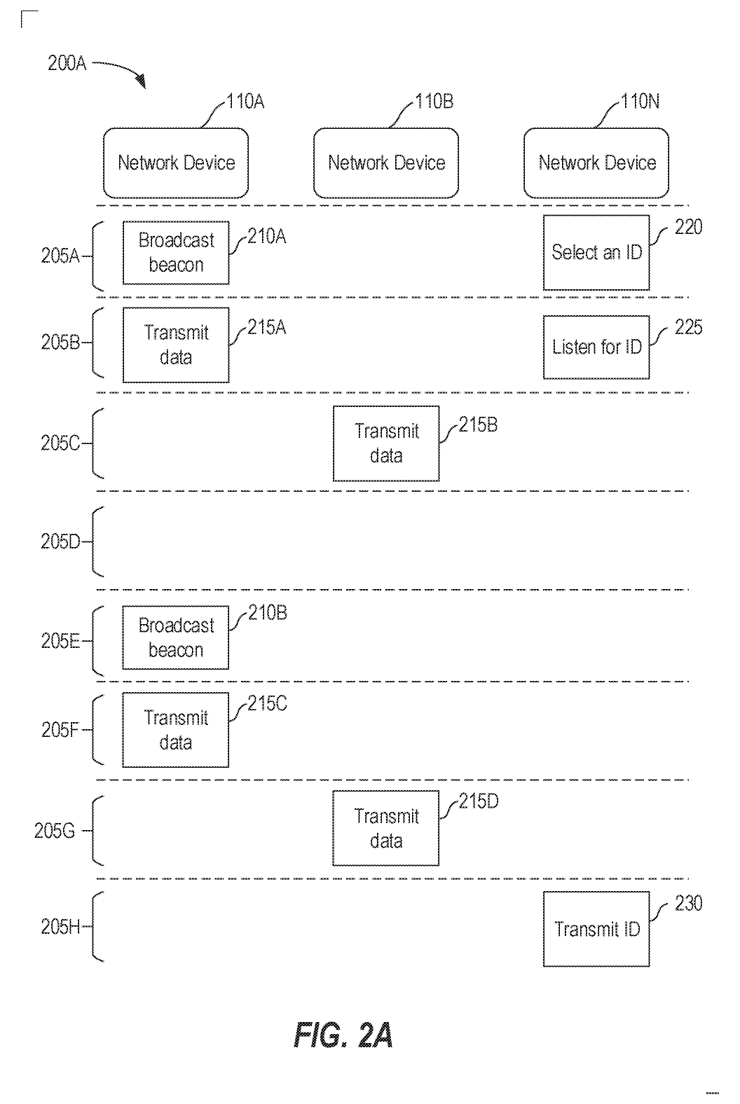

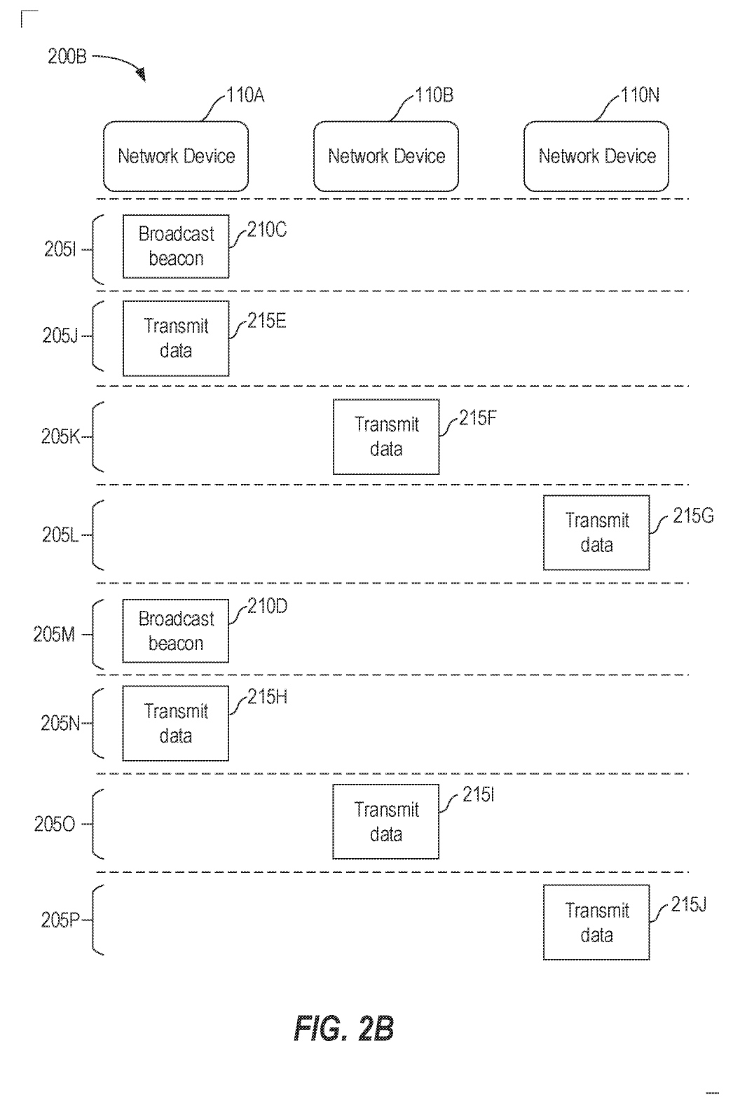

FIGS. 2A and 2B depict example workflows 200A and 200B for efficient identifier assignment for shared medium communication, according to some embodiments of the present disclosure.

As illustrated in FIG. 2A, the workflow 200A involves three network devices 110A-N, where the network devices 110A and 110B are already using a shared medium (e.g., the medium 115 of FIG. 1) to transmit and/or receive data, and the network device 110N is attempting to join the network. The illustrated workflow 200A is delineated into a sequence of time slots 205A-H, where each time slot 205 may span a defined period of time, as discussed above.

Although the illustrated example depicts the time slots 205 as having equal duration, in some embodiments, the actual duration of each time slot 205 may vary. For example, as discussed above, time slots 205 may be truncated if a node does not begin transmission at the beginning of the slot. As another example, in some embodiments, a time slot 205 may be ended whenever the node is finished transmitting (even if the defined maximum duration has not expired). In some embodiments, the time slots 205 may have dynamic or variable duration (e.g., allowing the node with current control of the medium to continue transmission until they finish or until a defined maximum duration or maximum packet size is reached). As another example, time slots 205 used for beacon transmission (e.g., to signal the beginning of the rotation) may be shorter than time slots 205 used for actual substantive data transmission.

In the illustrated example, during a first time slot 205A, the network device 110A (acting as the controller or manager of the rotation) broadcasts a beacon at block 210A via the shared medium. As discussed above, in some aspects, this broadcast beacon signals the beginning of the cycle or rotation of time slots 205. That is, each cycle or rotation may include the broadcast beacon itself, followed by a sequence of time slots 205 allocated for communication.

In the illustrated example, in response to the broadcast beacon, the network device 110A uses the time slot 205B to transmit data at block 215A. That is, the network device 110A knows that the first time slot 205B after the broadcast beacon is assigned to the node having the first node ID, which is the network device 110A. Therefore, when this time slot 205B begins, the network device 110A immediately begins transmitting data (if any is ready for transmitting). In some embodiments, as discussed above, the network device 110A may optionally refrain from initiating transmission, allowing the time slot 205B to be truncated and the next time slot 205C to begin sooner. During the time slot 205B, the network device 110B refrains from transmitting via the medium, as the time slot 205B is not assigned to the network device 110B. Although the illustrated example depicts the network device 110A using the time slot 205B, in some aspects, the first time slot 205B after the beacon may belong to the next node (e.g., the network device 110B) or any other node in the network.

Further, in the illustrated example, the network device 110N begins the initialization process during the time slot 205A by selecting an ID at block 220. In some embodiments, as discussed above, the network device 110N may select the ID at block 220 using any suitable criteria or technique, including randomly or pseudo-randomly. In some embodiments, if the network device 110N has been preconfigured with an ID (e.g., used previously by the network device 110N prior to restarting or otherwise re-enrolling), the network device 110N may select this previous ID at block 220. For example, the network device 110N may select a node ID of “n”.

As illustrated by block 225, the network device 110N further begins listening to messages (e.g., packets) transmitted via the medium. For example, as discussed above, each message transmitted via the medium may indicate or specify the node ID of the transmitting network device 110 and/or the node ID of the intended recipient (if any) of the message. In some embodiments, at block 225, the network device 110N may evaluate received messages to determine whether any specify the selected ID “n” (selected at block 220) as the sending node. Although depicted as a single instance of listening for the ID, as discussed above, the network device 110N may continue to evaluate received messages until a broadcast delay value (e.g., a randomly selected duration of time, number of cycles, or number of time slots) has elapsed. For example, during time slot 205B, the network device 110N may receive the data transmitted by the network device 110A (at block 215A), and may evaluate the message to confirm that it does not indicate the selected ID “n” (selected at block 220) as the sending node, as well as further messages (such as the data transmitted at block 210B, the data transmitted at block 215B, the data transmitted at block 215C, the data transmitted at block 215D, and so on, as discussed below).

Further, although the illustrated example depicts the network device 110N listening for use of the selected ID at multiple time slots, in some embodiments, the network device may evaluate message(s) received during the time slot that corresponds to the selected node ID (e.g., the time slot 205D, discussed in more detail below) to determine whether any message(s) are sent during this assigned time slot. As another example, in some embodiments, the network device may evaluate the detected messages across multiple time slots to determine whether the selected node ID is used as the intended recipient of any messages (which may indicate that the selected ID is already in use).

In the illustrated workflow 200A, once the time slot 205B ends (e.g., because the network device 110A finishes transmitting data, because a maximum duration or size of the time slot 205B has been reached, and the like), the time slot 205C begins and the network device 110B transmits data at block 215B. That is, if the network device 110B has any data to be transmitted, the network device 110B performs this transmission during the time slot 205C. For example, as discussed above, the network device 110B may know, based on its node ID, that the second time slot 205 of the cycle is reserved for the network device 110B. As discussed above, other network devices (e.g., the network device 110A) in the network may refrain from transmitting via the medium during this time slot 205C. Further, as discussed above, the network device 110N may evaluate the message transmitted at block 215B to confirm that it does not specify node ID “n” as the sending node.

In the illustrated example, once the time slot 205C ends, the time slot 205D begins. However, as the time slot 205D (e.g., the third slot after the beacon) is not assigned to a network device 110, no data is transmitted during this slot. In some embodiments, as discussed above, the time slot 205D may be truncated or ended early in response to determining that no transmission was initiated within a (relatively brief) window of time at the beginning of the time slot 205D.

In the workflow 200A, the time slot 205D was the last slot of the cycle. That is, the illustrated architecture is configured to support three network devices 110 using a single shared medium for conceptual clarity. Generally, the maximum number of supported devices may vary depending on the implementation (e.g., eight supported devices).

When the time slot 205E begins, the network device 110A knows that the previous cycle has ended and therefore transmits a new broadcast beacon at block 210B to signal the beginning of a new cycle. In the illustrated example, in response to the broadcast beacon, the network device 110A uses the next time slot 205F to transmit data at block 215C. That is, the network device 110A knows that the first time slot 205F after the broadcast beacon is assigned to the network device 110A. Therefore, when this time slot 205F begins, the network device 110A immediately begins transmitting data (if any is ready for transmitting). In some embodiments, as discussed above, the network device 110A may optionally refrain from initiating transmission, allowing the time slot 205F to be truncated. During the time slot 205F, the remaining network devices 110B-N refrain from transmitting via the medium, as discussed above.

Further, as discussed above, the network device 110N may continue to evaluate received messages (if the broadcast delay has not expired) to confirm that no other nodes are using the selected ID “n”.

As illustrated, once the time slot 205F ends, the network device 110B takes control of the medium (based on its assigned node ID) and uses it to transmit data at block 215D. As discussed above, this rotation-based approach to sharing the medium may continue for any number of cycles.

In the illustrated workflow 200A, the network device 110N may determine (at some point after the time slot 205B but at or prior to the time slot 205G) that the determined broadcast delay has ended. Therefore, when the time slot 205 that corresponds to the selected node ID “n” begins (e.g., time slot 205H, which is the third slot of the cycle), the network device 110N transmits a message containing the selected ID “n” at block 230. In some aspects, as discussed above, this transmission (at block 230) may generally correspond to a broadcast message via the medium indicating that the network device 110N intends to begin using the selected ID and/or time slot.

Although not depicted in the illustrated example, in some embodiments, if the network device 110N determines (based on the evaluation discussed above with respect to block 225) that another node is using the selected node ID “n” (e.g., another message, such as the data transmitted by the network device 110B at block 215B specifies node ID “n” as the origin of the message), the network device 110N may cease further listening and may perform block 220 anew (e.g., to select a new node ID). That is, the network device 110N may perform block 230 if the broadcast delay period elapses without detecting such a conflict.

In some embodiments, after or during transmission of the selected ID at block 230, the network device 110N may determine whether the transmission collided with data transmitted by any other nodes using the medium. For example, each network device 110 may include one or more components that detect such collisions on the medium. That is, even if multiple cycles have passed, the selected node ID “n” may already be used by another node (e.g., if the other network device 110 did not have any data to transmit during the cycle(s)). However, if the other network device 110 transmits a message during the time slot 205H, the other network device and/or the network device 110N may detect this collision with the broadcast transmitted by the network device 110N at block 230.

In some embodiments, if the network device 110N detects such a collision, the network device 110N may restart the process (e.g., selecting a new node ID, as discussed above) and refrain from further use of the initially selected ID. In some embodiments, if another network device 110 detects (based on the data transmitted at block 230) that the network device 110N intends to begin using the ID that the other network device 110 is already using, the network device 110 may broadcast a message during the subsequent assigned time slot (e.g., the next time slot assigned to the other network device 110) that the selected ID is in use. As discussed above, the network device 110N may respond by restarting the allocation process.

Turning to FIG. 2B, the workflow 200B continues with time slot 205I. During the time slot 205I, as the previous cycle has completed, the network device 110A transmits another broadcast beacon at block 210C to signal the beginning of a new cycle.

In the illustrated example, in response to the broadcast beacon, the network device 110A uses the next time slot 205J to transmit data at block 215E based on the time slot to node ID assignments, as discussed above. Further, in some embodiments, the network device 110N may continue to evaluate received messages (even though the broadcast delay has expired) to confirm that no other nodes are using the selected ID “n”.

As illustrated, once the time slot 205J ends, the network device 110B takes control of the medium (based on its assigned node ID) and uses it to transmit data at block 215F. In the illustrated workflow 200B, during the next time slot 205L, the network device 110N may then use the medium to transmit data at block 215G. That is, if the network device 110N determines that the allocation or enrollment process has completed (e.g., because no conflicts have been detected based on the broadcast transmitted at block 230 of FIG. 2A), the network device 110N may begin to communicate using the medium during the corresponding time slots.

Although the illustrated example depicts a single cycle as the allocation completion criteria (e.g., where the network device 110N determines that the selected ID “n” is available after transmitting a single broadcast indicating the selected ID), in some aspects, the allocation may be incomplete for multiple such cycles. For example, the network device 110N may spend a defined number of cycles and/or a defined duration of time broadcasting the selection of the ID “n” (e.g., for three time slots) before determining that the ID is unused and the allocation process is complete.

In some embodiments, as discussed above, the network device 110N may continue to monitor its ID selection broadcasts and/or received messages to determine whether any broadcast(s) collided with data transmitted by any other nodes and/or whether any other node transmitted data using the selected ID. If so, the network device 110N may restart the process (e.g., selecting a new node ID, as discussed above) and refrain from further use of the initially selected ID.

Once the network device 110N determines that the selected node ID is available, the allocation is complete and the network device 110N may begin using the selected ID for communication (e.g., to transmit data at block 215G during the assigned time slot 205L). In some embodiments, as discussed above, the network device 110N may save, store, or otherwise record the selected ID (e.g., in non-volatile memory) to seed future allocation processes (e.g., after a power cycle).

As illustrated, after time slot 205L, the cycle ends and the network device 110A transmits another broadcast beacon at block 210D to signal the beginning of a new cycle. In the illustrated example, in response to the broadcast beacon, the network device 110A uses the next time slot 205N to transmit data at block 215H. Once the time slot 205N ends, the network device 110B takes control of the medium (based on its assigned node ID) and uses the medium to transmit data at block 215I. In the illustrated workflow 200B, during the next time slot 205P, the network device 110N may then use the medium to transmit data at block 215J.

In this way, the network device 110N can automatically find and begin using a unique node ID to communicate using a shared medium without causing undue interference in the medium and without relying on any manual configuration or assignment. This allows new network devices to be rapidly and easily added to the shared medium, enabling substantial flexibility and scalability of the network and enhanced communications among network devices.

As discussed above, this flexibility may significantly improve the operations of the overall computing system. For example, in the case of a vehicle-based deployment, new network devices (e.g., sensors, cameras, speakers, lights, and the like) May be readily added by simply connecting them to the existing shared medium (e.g., a bus) without any manual configuration.

### Example Method for Efficient Use of a Shared Communication Medium

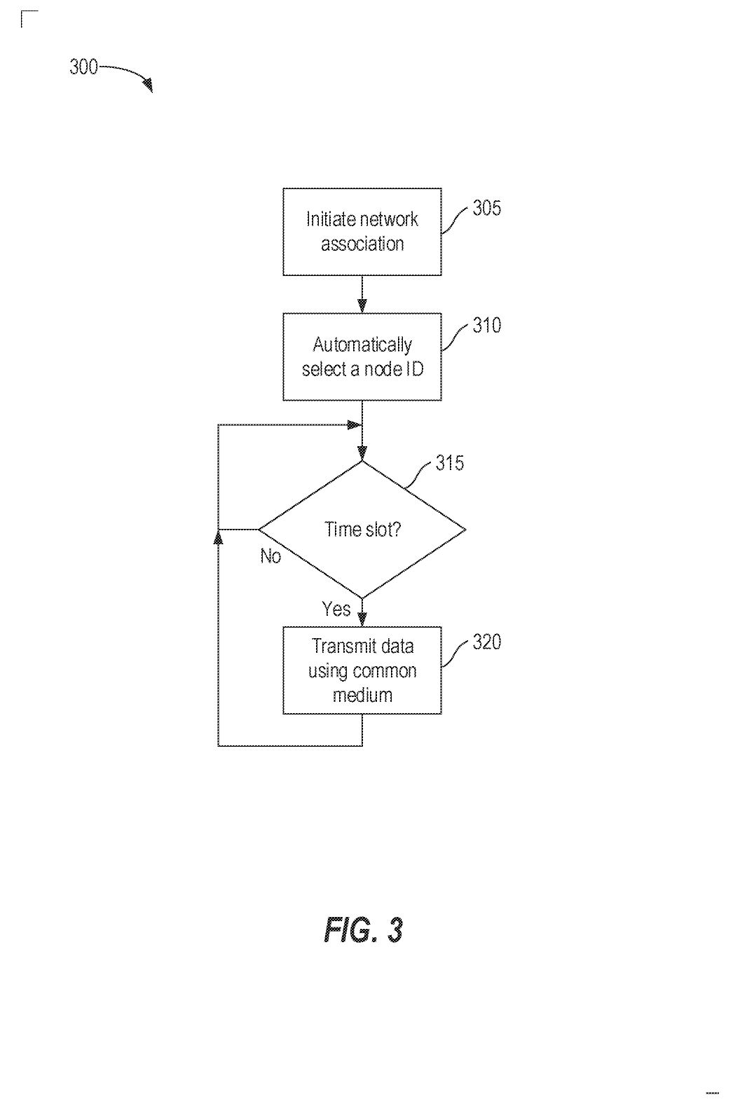

FIG. 3 is a flow diagram depicting an example method 300 for efficient use of a shared communication medium, according to some embodiments of the present disclosure. In some embodiments, the method 300 is performed by a network device, such as the network device(s) 110 of FIGS. 1, 2A, and/or 2B.

At block 305, the network device initiates a network association to a network that uses a shared communication medium (e.g., the medium 115 of FIG. 1). As used herein, initiating the association can generally include a wide variety of operations, such as powering up or turning on (e.g., when the network device enters an active or powered state), when the network device is communicably coupled to the shared medium (e.g., plugged into the bus), or otherwise determines to begin communicating via the shared medium.

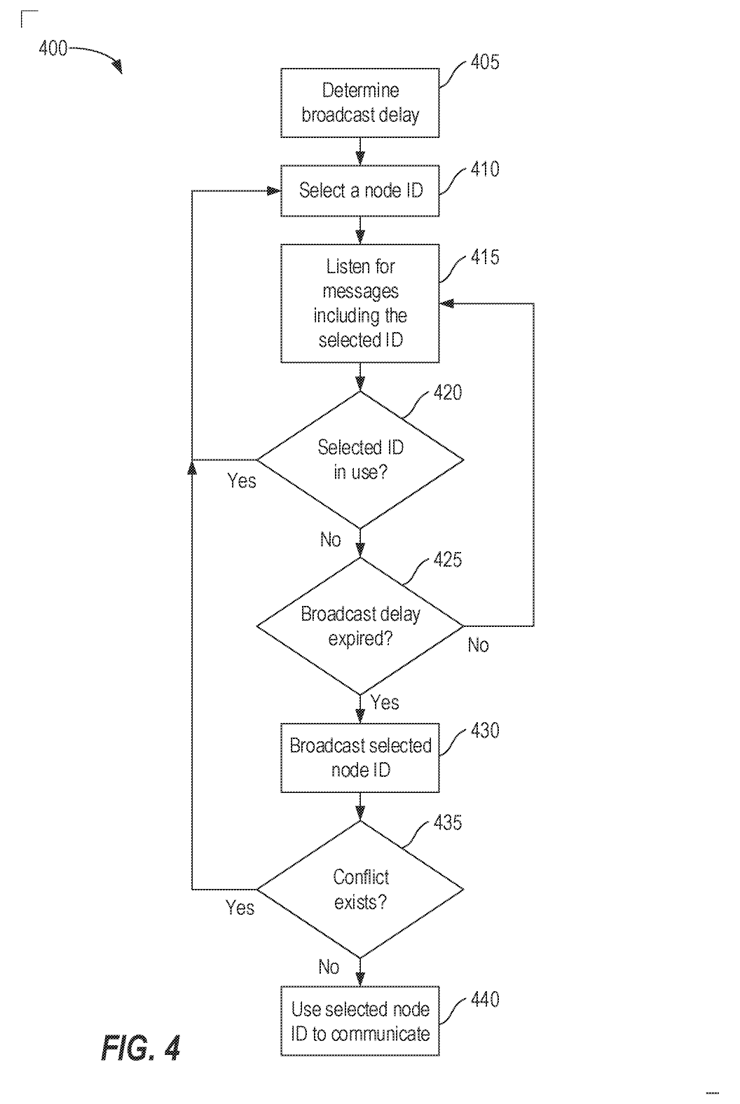

At block 310, the network device automatically selects a node ID for use in communicating using the shared medium. For example, as discussed above with reference to the workflows 200A and 200B of FIGS. 2A and 2B, the network devices that use the shared medium may use a time slot reservation approach where, for each cycle, each node ID has an assigned time slot for communication. As discussed above, in some embodiments, each network device should use a unique node ID (which corresponds to a unique time slot in each cycle) to prevent collisions among data transmissions. However, as the newly-added network device has no knowledge of the available IDs, as discussed above, the network device may perform an automatic node ID selection process to find a unique (unused) ID. One example method for performing the block 310 is discussed in more detail below with reference to FIG. 4.

At block 315, after selecting a unique node ID, the network device determines whether a time slot assigned to the network device (based on the selected ID) has begun. For example, as discussed above, the network device may select the node ID “n”, indicating that the n-th time slot (after the beacon) should be used by the network device. In some embodiments, therefore, the network device may listen for the broadcast beacon (indicating the beginning of the cycle) and may then count the time slots as they occur (e.g., the number of data transmissions by other nodes and/or the number of truncated slots caused by silence on the line) until the network device’s assigned slot arrives.

If the current time slot is not assigned to the network device, the network device may refrain from transmitting any data via the shared medium and the method 300 loops at block 315. In some aspects, during the current time slot, the network device may monitor or evaluate any messages received via the medium (e.g., to determine whether the message(s) are intended for the network device, or to determine whether any other devices are using or proposing to use the network ID that the network device selected).

If, at block 315, the network device determines that the time slot assigned to the network device has arrived, the method 300 continues to block 320, where the network device transmits data using the shared or common communications medium, as discussed above. For example, if the network device has any data ready for transmission, the network device may use the shared medium to transmit one or more packets or messages via the medium. As discussed above, in some embodiments, the message(s) may identify the network device as the sending device (e.g., using the selected node ID). In some embodiments, the message(s) may further indicate the destination device (e.g., using a node ID) and/or may be broadcast (e.g., intended to be received by all nodes).

As discussed above, the network device may refrain from transmitting data if the network device has no data for transmission. In some embodiments, if the network device refrains from initiating a transmission within a defined period from the beginning of the time slot, the time slot may be truncated and the cycle may proceed to the next slot (e.g., the network device having the next node ID may begin its transmission, if any). Similarly, in some embodiments, as discussed above, the time slot may have a dynamic or variable length (e.g., the slot may continue until the network device finishes transmitting its data, or until a defined maximum is reached).

After transmitting (or refraining from transmitting) data at block 320, the method 300 returns to block 315. In this way, the network device seamlessly joins the network and begins communicating using a unique identifier without relying on any manual configuration.

### Example Method for Automated Identifier Assignment for Communication Using a Shared Medium

FIG. 4 is a flow diagram depicting an example method 400 for automated identifier assignment for communication using a shared medium, according to some embodiments of the present disclosure. In some embodiments, the method 400 is performed by a network device, such as the network device(s) 110 of FIGS. 1, 2A, and/or 2B, and/or by the network device discussed above with reference to FIG. 3. In some embodiments, the method 400 provides additional detail for the block 310 of FIG. 3.

At block 405, the network device determines a broadcast delay. As discussed above, the broadcast delay generally corresponds to a period during which the network device listens for conflicting messages (e.g., messages using a node ID that the network device intends to use) on the shared medium prior to beginning use of the selected ID. For example, in some embodiments, the broadcast delay corresponds to a length of time (e.g., for a defined number of seconds), a number of time slots, a number of communication cycles (e.g., until a defined number of beacons indicating the beginning of a cycle have been received), and the like.

Generally, the network device may select the broadcast delay using any suitable technique or criteria. For example, in some embodiments, the network device selects the broadcast delay randomly (or pseudo-randomly) between a value of zero (e.g., indicating no delay) and a defined maximum delay value. In some embodiments, each network device may use the same defined delay. In other embodiments, each network device may select its own broadcast delay.

At block 410, the network device selects a node ID. In some embodiments, as discussed above, the network device selects the node ID from a defined range (e.g., between one and the maximum number of nodes that the architecture supports). In some embodiments, as discussed above, the network device may determine whether there is a pre-selected or configured node ID for the network device. For example, the network device may determine whether one or more non-volatile storages of the network device include a node ID to initiate the selection process. In some embodiments, for example, the network device may have previously stored the node ID in response to determining that the ID was unused in the network. As another example, a user (e.g., an administrator of the network) may have preconfigured the network device with an initial node ID (which is not binding).

In some aspects, the network device may select the node ID randomly (or pseudo-randomly), as discussed above. For example, if no preconfigured node ID exists for the network device (or if the network device does not use such preemptive configuration), the network device may randomly select a node ID from the allowable range. In some aspects, the node ID selected at block 410 may be referred to as an initial node ID or an initial selection.

At block 415, the network device listens for any messages, transmitted via the common medium, that include the initial node ID selected by the network device (at block 410). That is, the network device may determine, track, evaluate, or monitor the specified source or transmitting device ID included in any message(s) received over the network.

At block 420, the network device determines whether the selected node ID (selected at block 410) is already in use in the network. For example, the network device may determine whether any of the received messages specify the selected node ID as the source or transmitting device for the message. If so, the selected initial node ID is already being used by another device in the network, and the method 400 returns to block 410 to select a new node ID. Although the illustrated example depicts returning to block 410, in some aspects, the method 400 may return to block 405 to select a new broadcast delay. As discussed above, the network device may select the new ID using any suitable technique, including randomly or pseudo-randomly. In some aspects, the network device selects the new ID from a subset of the total range of IDs. For example, the network device may eliminate, from the range, any node IDs that were observed as in use (based on messages received at block 415). The network device may then select a new node ID from this subset of node IDs.

Returning to block 420, if the network device determines that none of the received message(s) specified the selected initial node ID as the sending node, the method 400 continues to block 425. At block 425, the network device determines whether the broadcast delay (determined at block 405) has expired. If not, the method 400 returns to block 415 to continue monitoring incoming messages via the medium. If, at block 425, the network device determines that the broadcast delay has expired, the method 400 continues to block 430.

At block 430, the network device broadcasts the initially selected node ID via the network. For example, as discussed above, the network device may transmit a message, via the shared communication medium, indicating the selected ID as the sender and all nodes on the medium as the intended recipient. In some aspects, as discussed above, this selection broadcast may generally indicate the network device’s intention to use the indicated node ID for future communications. Although illustrated as occurring a single time at block 430, in some aspects, the network device may perform multiple such broadcasts, as discussed above.

In some embodiments, as discussed above, broadcasting the selected node ID may include transmitting the selection in accordance with the selected node ID. That is, the network device may wait until the time slot assigned to the selected node ID arrives, and then use the time slot to transmit the broadcast. In some embodiments, as discussed above, the network device may continue to monitor received messages while waiting for the assigned time slot to begin.

At block 435, the network device determines, based on the one or more selection broadcasts, whether a conflict exists (e.g., whether the selected ID causes a conflict). That is, the network device may determine whether the initially selected node ID is in use in the network. For example, as discussed above, the network device may determine whether any of the broadcast(s) collided with another transmission in the medium (e.g., another device used the same time slot to transmit data). If so (e.g., if the selected node ID caused a conflict, the network device may determine that the selected ID is in use. As another example, the network device may determine whether any further received messages (e.g., from other devices) use the selected ID.

In some embodiments, as discussed above, if a given network device detects that another device is using the time slot assigned to the given network device (e.g., while the given network device is refraining from transmitting data for one or more cycles), such as a broadcast indicating that the other device intends to use the given network device’s node ID, the given network device may transmit a message (in the next assigned time slot) to indicate that it retains use of the time slot and node ID, regardless of whether the given network device actually has data to be transmitted. This may allow new network device(s) to rapidly identify conflicts, even with respect to network devices that are relatively quiet (e.g., rarely transmitting), and even with relatively short broadcast delays (which can accelerate the onboarding process for new nodes).

If a conflict exists (e.g., if the selected ID is conflicting), the method 400 returns to block 410. Although the illustrated example depicts returning to block 410, in some aspects, the method 400 may return to block 405 to select a new broadcast delay. If no conflict is detected or exists (e.g., if the selected ID is nonconflicting), the method 400 continues to block 440. At block 440, the network device then uses the selected node ID to communicate via the network. For example, as discussed above, the network device may begin transmitting data to one or more recipients during time slot(s) assigned to the selected node ID, using the node ID as the sender or source of the message(s). In this way, the network device is seamlessly brought online without manual effort. In some embodiments, these communications (using the selected ID) may be referred to as unicast transmissions to indicate that the transmission(s) have an intended recipient (as compared to the broadcasts discussed above). Nevertheless, in some aspects, other devices may still detect or see these unicast messages (e.g., on the shared medium), which enables the automated selection of node ID discussed above.

In some embodiments, as discussed above, the network device may save or store the selected ID locally (e.g., in non-volatile memory), allowing the network device to rapidly come online in the future. For example, after a power cycle or reboot, the network device may select (at block 410), the (previously conflict-free) node ID it stored, reducing the probability that a new conflict will occur and accelerating the onboarding process.

### Example Method for Selecting Node Identifiers for Communication

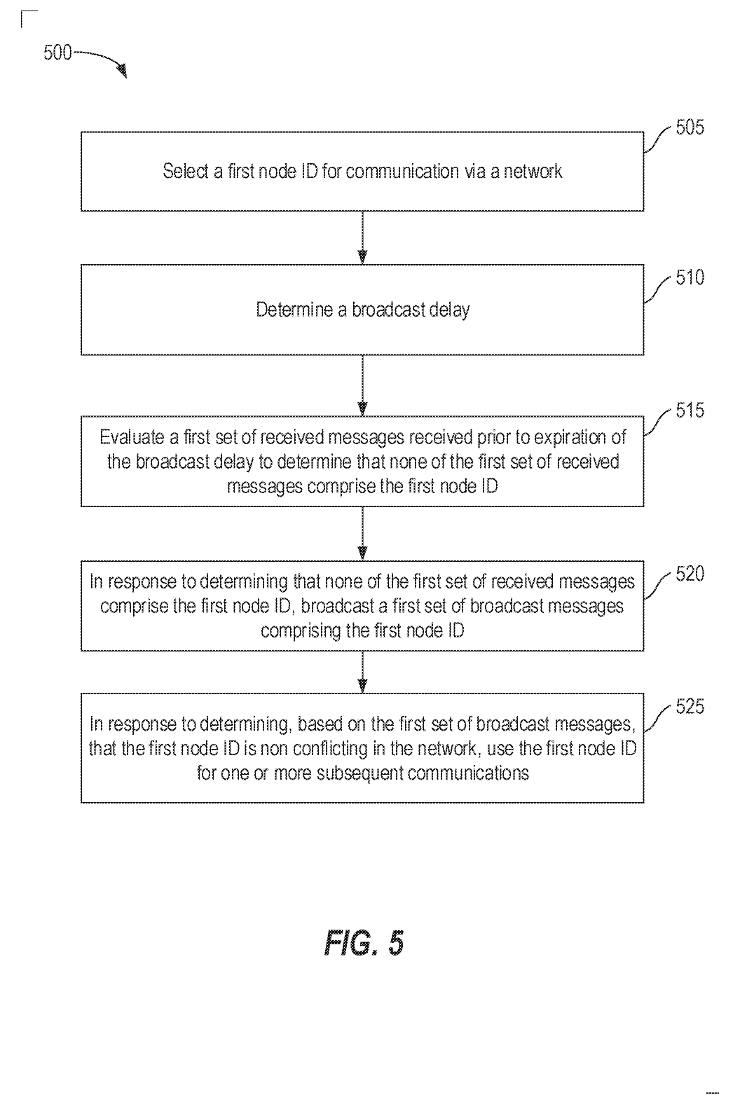

FIG. 5 is a flow diagram depicting an example method 500 for selecting node identifiers for communication, according to some embodiments of the present disclosure. In some embodiments, the method 500 is performed by a network device, such as the network device(s) 110 of FIGS. 1, 2A, and/or 2B, and/or by the network device discussed above with reference to FIGS. 3 and/or 4.

At block 505, a first node ID for communication via a network (e.g., the medium 115 of FIG. 1) is selected (e.g., at block 220 of FIG. 2A).

At block 510, a broadcast delay is determined.

At block 515, a first set of received messages received prior to expiration of the broadcast delay (e.g., transmitted at blocks 215A and/or 215B of FIG. 2A) is evaluated (e.g., at block 225 of FIG. 2A) to determine that none of the first set of received messages comprise the first node ID.

At block 520, in response to determining that none of the first set of received messages comprise the first node ID, a first set of broadcast messages comprising the first node ID is broadcast (e.g., at block 230 of FIG. 2A).

At block 525, in response to determining, based on the first set of broadcast messages, that the first node ID is nonconflicting in the network, the first node ID is used for one or more subsequent communications (e.g., at blocks 215G and 215J of FIG. 2B).

### Example Computing Device for Selecting Identifiers for Communication

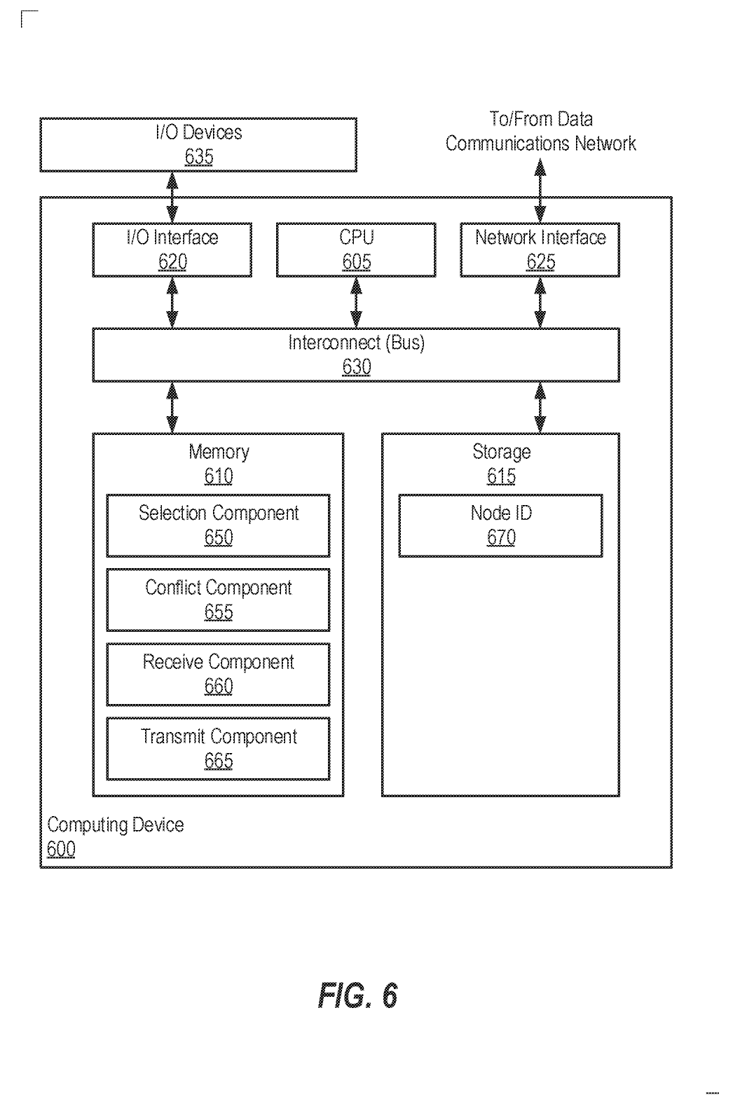

FIG. 6 depicts an example computing device 600 for selecting identifiers for communication, according to some embodiments of the present disclosure.

Although depicted as a physical device, in some embodiments, the computing device 600 may be implemented using virtual device(s), and/or across a number of devices (e.g., in a cloud environment). In some embodiments, the computing device 600 corresponds to or comprises a network device, such as the network device(s) 110 of FIGS. 1, 2A, and/or 2B, and/or by the network device discussed above with reference to FIGS. 3, 4, and/or 5.

As illustrated, the computing device 600 includes a CPU 605, memory 610, storage 615, one or more network interfaces 625, and one or more I/O interfaces 620. In the illustrated embodiment, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally considered to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630. In the illustrated embodiment, the memory 610 includes a selection component 650, a conflict component 655, a receive component 660, and a transmit component 665.

Although depicted as discrete components for conceptual clarity, in some embodiments, the operations of the depicted components (and others not illustrated) may be combined or distributed across any number of components. Further, although depicted as software residing in memory 610, in some embodiments, the operations of the depicted components (and others not illustrated) may be implemented using hardware, software, or a combination of hardware and software.

In the illustrated embodiment, the selection component 650 may be used to select node IDs for use in communicating via a shared network or medium, as discussed above. For example, the selection component 650 may use a variety of techniques or operations to select the node ID (e.g., based on prior configuration, based on random or pseudo-random selection, and the like).

In the illustrated example, the conflict component 655 may be used to determine whether selected node IDs (selected by the selection component 650) would cause any conflict in the network, as discussed above. For example, the conflict component 655 may evaluate received messages to determine whether any specify the selected node ID and/or whether any messages were sent during the time slot that corresponds to the node ID. As another example, the conflict component 655 may determine whether any messages transmitted by the computing device 600 (during the corresponding time slot) collided with message(s) from other nodes. If a conflict exists, as discussed above, the selection component 650 may be tasked with selecting a new ID.

In the illustrated embodiment, the receive component 660 may be used to receive data via the shared medium, as discussed above. For example, the receive component 660 may listen on the medium for message(s) (e.g., data packets) transmitted on the medium, and determine whether the message(s) indicate the computing device 600 as the intended recipient (e.g., based on the node ID used by the computing device 600). If so, the receive component 660 may be used to parse the message and perform any corresponding actions, depending on the implementation.

In the illustrated example, the transmit component 665 may be used to transmit data (e.g., messages or packets) via the shared medium using the node ID used by the computing device 600. For example, the transmit component 665 may monitor the medium to determine when a time slot assigned to the computing device 600 has arrived, and use such time slots to transmit data via the shared medium, as discussed above.

In the illustrated example, the storage 615 may include a node ID 670. In some embodiments, as discussed above, the node ID 670 may be stored once the conflict component 655 determines that the ID is not currently in use in the network. That is, the computing device 600 may store the node ID 670 for future use. For example, during future re-allocations (e.g., after restarting), the selection component 650 may (at least initially) select the node ID 670, rather than using random selection. This may reduce the time consumed by the allocation process.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to the described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to embodiments of the present disclosure shall not be construed as a generalization of any subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present embodiments may be a system, a method, and/or a computer program product. The computer program product may include a computer readable storage medium (or media) having computer readable program instructions thereon for causing a processor to carry out aspects of the present embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the present embodiments are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications (e.g., node allocation criteria or techniques) or related data available in the cloud. For example, the system could execute on a computing system in the cloud and evaluate shared mediums to detect conflicts. In such a case, the system could perform ID selection, and store the selected IDs at a storage location in the cloud. Doing so allows a user to access this information from any computing system attached to a network connected to the cloud (e.g., the Internet).

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
selecting, by a network device, a first node identifier (ID) for communication via a network;
determining a broadcast delay;
evaluating a first set of received messages received prior to expiration of the broadcast delay to determine that none of the first set of received messages comprise the first node ID;
in response to determining that none of the first set of received messages comprise the first node ID, broadcasting, by the network device, a first set of broadcast messages comprising the first node ID; and
in response to determining, based on the first set of broadcast messages, that the first node ID is nonconflicting in the network, using the first node ID for one or more subsequent communications.

2. The method of claim 1, further comprising storing, by the network device, the first node ID for subsequent ID allocation operations.

3. The method of claim 1, wherein selecting the first node ID comprises randomly selecting the first node ID from a defined range of node IDs.

4. The method of claim 1, wherein selecting the first node ID comprises retrieving the first node ID from a storage of the network device, wherein the first node ID was previously used by the network device for communications via the network.

5. The method of claim 1, wherein determining the broadcast delay comprises randomly selecting the broadcast delay from a defined range of broadcast delays.

6. The method of claim 1, further comprising:
selecting, by the network device, a second node ID;
evaluating a second set of received messages received prior to expiration of a second broadcast delay to determine whether any of the second set of received messages includes the second node ID; and
in response to determining that at least one of the second set of received messages includes the second node ID, selecting, by the network device, a third node ID.

7. The method of claim 1, further comprising:
broadcasting, by the network device, a second set of broadcast messages including a second node ID; and
in response to determining, based on the second set of broadcast messages, that the second node ID caused a conflict in the network, selecting, by the network device, a third node ID.

8. The method of claim 7, wherein determining that the second node ID caused a conflict comprises at least one of:
(i) determining that another network device transmitted a message using the second node ID, or
(ii) determining that another network device transmitted a message during a time slot allocated to the second node ID.

9. The method of claim 1, wherein using the first node ID for one or more subsequent communications comprises transmitting, by the network device, one or more messages during one or more time slots allocated to the first node ID.

10. A system comprising:
a processor;
a memory collectively storing computer executable instructions, that when executed by the processor, cause the system to perform operations, comprising:
selecting, by the system, a first node identifier (ID) for communication via a network;
determining a broadcast delay;
evaluating a first set of received messages received prior to expiration of the broadcast delay to determine that none of the first set of received messages comprise the first node ID;
in response to determining that none of the first set of received messages comprise the first node ID, broadcasting, by the system, a first set of broadcast messages comprising the first node ID; and
in response to determining, based on the first set of broadcast messages, that the first node ID is nonconflicting in the network, using the first node ID for one or more subsequent communications.

11. The system of claim 10, the operation further comprising storing, by the system, the first node ID for subsequent ID allocation operations, wherein selecting the first node ID comprises retrieving the first node ID from a storage of the system, wherein the first node ID was previously used by the system for communications via the network.

12. The system of claim 10, the operation further comprising:
selecting, by the system, a second node ID;
evaluating a second set of received messages received prior to expiration of a second broadcast delay to determine whether any of the second set of received messages includes the second node ID; and
in response to determining that at least one of the second set of received messages includes the second node ID, selecting, by the system, a third node ID.

13. The system of claim 10, the operation further comprising:
broadcasting, by the system, a second set of broadcast messages including a second node ID; and
in response to determining, based on the second set of broadcast messages, that the second node ID caused a conflict in the network, selecting, by the system, a third node ID.

14. The system of claim 12, wherein determining that the second node ID caused a conflict comprises at least one of:
(i) determining that another system transmitted a message using the second node ID, or
(ii) determining that another system transmitted a message during a time slot allocated to the second node ID.

15. The system of claim 10, wherein using the first node ID for one or more subsequent communications comprises transmitting, by the system, one or more messages during one or more time slots allocated to the first node ID.

16. A computer program product comprising one or more computer-readable storage media having computer-readable program code collectively embodied therewith, the computer-readable program code collectively executable by one or more computer processors to perform an operation comprising:
selecting, by a network device, a first node identifier (ID) for communication via a network;
determining a broadcast delay;
evaluating a first set of received messages received prior to expiration of the broadcast delay to determine that none of the first set of received messages comprise the first node ID;
in response to determining that none of the first set of received messages comprise the first node ID, broadcasting, by the network device, a first set of broadcast messages comprising the first node ID; and
in response to determining, based on the first set of broadcast messages, that the first node ID did is nonconflicting in the network, using the first node ID for one or more subsequent communications.

17. The computer program product of claim 16, the operation further comprising:
selecting, by the network device, a second node ID;
evaluating a second set of received messages received prior to expiration of a second broadcast delay to determine whether any of the second set of received messages includes the second node ID; and
in response to determining that at least one of the second set of received messages includes the second node ID, selecting, by the network device, a third node ID.

18. The computer program product of claim 16, the operation further comprising:
broadcasting, by the network device, a second set of broadcast messages including a second node ID; and
in response to determining, based on the second set of broadcast messages, that the second node ID caused a conflict in the network, selecting, by the network device, a third node ID.

19. The computer program product of claim 18, wherein determining that the second node ID caused a conflict comprises at least one of:
(i) determining that another network device transmitted a message using the second node ID, or
(ii) determining that another network device transmitted a message during a time slot allocated to the second node ID.

20. The computer program product of claim 16, wherein using the first node ID for one or more subsequent communications comprises transmitting, by the network device, one or more messages during one or more time slots allocated to the first node ID.
